(19) United States
(12) Patent Application Publication
(10) Pub. No.: US 2014/0263071 A1
(43) Pub. Date: Sep. 18, 2014

(54) METHOD FOR COLLECTING METALS

(71) Applicant: CHEMEC OY AB, ESPOO (FI)

(72) Inventors: Petri Turhanen, Kuopio (FI); Sirpa Peraniemi, Kuopio (FI); Jouko Vepsalainen, Kuopio (FI)

(73) Assignee: CHEMEC OY AB, ESPOO (FI)

(21) Appl. No.: 14/009,207

(22) PCT Filed: Mar. 30, 2012
(86) PCT No.: PCT/FI12/50322

§ 371 Date: Oct. 30, 2013

(30) Foreign Application Priority Data
Apr. 1, 2011 (FI) 20115315

(51) Int. Cl. C02F 1/68

(52) U.S. Cl. CPC C02F 1/683; C02F 2101/20
USPC 210/666; 210/729; 210/728

(57) ABSTRACT

A method for collecting metals from a solution, in which method solid insoluble or sparingly soluble bisphoshonate of formula I

[chemical structure]

is mixed with the solution, whereby metals possibly present in the solution react with the bisphosphonate, and the bisphosphonate together with the metals reacted with it is separated from the solution. The method can be used for collecting metals e.g. from waste water or from household water.

### FIELD OF THE INVENTION

The present invention relates generally to the fields of chemical synthesis, analytical chemistry, green chemistry and separation science. More particularly, the invention concerns collecting metals from liquids, especially from water solutions.

### BACKGROUND OF THE INVENTION

Various separation techniques have been used for collecting metal ions from solutions. In general, the collection procedure should be simple, relatively rapid, quantitative and not very expensive. The procedure should also require minimum sample pretreatment. In such a procedure chelating precipitants may be used. Typically, such chelating precipitants contain groups with replaceable hydrogen atoms, such as carboxyl (—COOH), hydroxyl (—OH), mercapto (—SH) or sulfonic (—SO₃H) groups, together with functional groups of basic character, such as amino (—NH₂), amino(cyclic) (—NH—), imino (═N—), carbonyl (>CO) or thioketo (>CS), with which the reacting metal is coordinated to form a four-, five- or six-membered ring (Peräniemi, S. Preconcentration of phosphorus, chromium, arsenic, selenium, mercury and gold onto activated charcoal before determination by EDXRF, Yliopistopaino, Helsinki, 1995). Most popular chelating agents for the precipitation are dithiocarbamates because of the low aqueous solubility of their metal chelates. Dithiocarbamates have high affinity for transition metals and very low affinity for alkaline and alkaline earth metal. Precipitation is carried out for a single element or a group of elements. When the concentrations of metals is very low, quantitative precipitation and collection of precipitate may be achieved through the addition of a coprecipitant (carrier) or binding the chelating agents to a resin.

Methylenebisphosphonates (MBP), which are characterized by a P-C-P backbone, have been used for many purposes during their 50 years lifetime. In the beginning BPs acted as water softeners by inhibiting the crystallization of calcium salts, but the basis for their nowadays main use is a high affinity for bone mineral hydroxyapatite (Fleisch, H. Bisphosphonates in Bone Disease: From the Laboratory to the Patient, The Parthenon Publishing Group Inc.: New York, 1995). As effective inhibitors of bone resorption, BPs are used in bone diseases and disorders of calcium metabolism, e.g. osteoporosis (Yates, A. J.; Rodan, G. A. DDT, 3 (1998) 69). BPs are also used as bone scanning agents if linked to a gamma-emitting technetium isotope, bone-targeting promoieties,e.g. for anti-inflammatory drugs (Hirabayashi, H.; Sawamoto, T.; Fujisaki, J.; Tokunaga, Y.; Kimura, S.; Hata, T. Pharm. Res., 18 (2001) 646), solvent extraction reagents for actinide ions (Reddy, G. V.; Jacobs, H. K.; Gopalan, A. S.; Barrans Jr.; R. E.; Dietz, M. L.; Stepinski, D. C.; Herlinger, A. W. Synt. Commun., 34 (2004) 331), and as a new class of herbicides (Chuiko, A. L., Lozinsky, M. O., Jasicka-Misiak, I. and Kafarski, P. J. Plant. Growth Regul. 18 (1999) 171). Recently, MBPs have been used as growth inhibitors for parasitic diseases like malaria (Ghosh, S.; Chan, J. M. W.; Lea, C. R.; Meints, G. A.; Lewis, J. C.; Tovian, Z. S.; Flessner, R. M.; Loftus, T. C.; Bruchhaus, I.; Kendrick, H.; Croft, S. L.; Kemp, R. G. Kobayashi, S.; Nozaki, T.; Oldfield, E. J. Med. Chem., 47 (2004) 175) and in crystal engineering studies (Fu, R., Hu, S, and Wu, X. Crystal. Growth. Des. 7 (2007) 1134). BPs as such have not been used to collect metal ions without an additional resin. Commercially available BP-polystyrene ion-exchange resins (Diphonix®) have been used to uptake actinides (Horwitz, E. P., Chiarizia, R., Diamond, H., Gatrone, R. C., Alexandratos, S. D., Trochimczuk, A. Q. and Crick D. W. Solvent Extr. Ion Exch. 11 (1993) 943) and transition metals (Chiarizia, R., Horwitz, E. P., Gatrone, R. C., Alexandratos, S. D., Trochimczuk, A. Q. and Crick D. W. Solvent Extr. Ion Exch. 11 (1993) 967).

Unwanted metal cations typically exist not only in industrial waste waters, waters draining through dumping sides, ash from waste burning places and in drilling well waters, but also in chemicals which are used e.g. in water purification or in paper mills. Typically metal cations are in stable, dissolved aqueous form and are unable to form solids. Usually the goal in any collection process is to adsorb these cations to solid materials (e.g. resins) or precipitate them as complexes. Ion exchange resins can adsorb both negative and positive ions depending on the structure of the resin. Also activated carbon is largely used in purifications processes, since there is a large neutral surface which can adsorb efficiently also neutral organic compounds, bacteria, chloride, ammonium and to a certain extent also some metals, like chromium, cobalt and mercury. However, problems arise with charged particles. Ones the metals are solidified, these are removed e.g. by filtration.

Industry and mining activities introduce most of the heavy metal pollution in the environment although closed water recirculation systems are widely used. Conventional methods for the removal of toxic heavy metals include chemical precipitation, chemical oxidation or reduction, filtration, ion-exchange, electrochemical treatment and evaporation. Most commonly sewage is treated by adding chemicals which increase pH value and precipitate heavy metals. Sludge containing metals is then collected away. This method is somehow effective for the precipitation of e.g. copper and nickel but problems arise with silver, lead and zinc. The limitations of these techniques lead to incomplete metal removal and expensive equipments and monitoring systems. Furthermore, these techniques become ineffective and non-economical when the removal of heavy metals at very low concentrations is required.

Especially chromium possesses a serious environmental hazard since it is commonly used as a surface coating agent (galvanisation) and in leather industry. Chromium containing wastewaters are typically rather acidic, since toxic Cr(VI) is reduced to Cr(III) with NaHSO₃ or FeSO₄ under acidic conditions (pH<3). Several methods have been developed for the removal of Cr(III) from solutions. The methods are based e.g. on activated carbon but their use is restricted because of high cost and difficulty in regeneration.

Nowadays there is also a common demand for more and more environmentally friendly industrial applications, so called philosophy of green chemistry. The idea of green chemistry is to design products and processes that reduce or eliminate the use and generation of hazardous substances. Green chemistry is not only recycling of valuable metals, like noble metals (e.g. Au, Ag, Pt, Pd) or metals in electronic industry (e.g. Ga, Nb, Ta), but also the materials used in recycling processes should be environmentally friendly. For example, typical ion exchange resin contains complexation agent which is bound e.g. to styrene polymer. The material is “greener”, if ion exchange properties are obtained without using resin and if regeneration is easy.

### SUMMARY OF THE INVENTION

Now the invention in accordance with the claims has been made.

The present invention provides a new method for collecting metals from solutions by complexing them with a solid and insoluble or sparingly soluble bisphoshonate of formula I

[chemical structure]

wherein:
A is a (CR¹R²)ₘ—(CR³R⁴)ₙ—(CR⁵R⁶)ₒ— chain,
B is a (CR¹R²)ₘ—(CR³R⁴)ₙ—(CR⁵R⁶)ₒ— chain,
   wherein
   k is 0, 1, or 2,
   m is 0, 1, 2, 3, 4, 5, or 6,
   n is 0, 1, 2, 3, 4, 5, or 6,
   o is 0, 1, 2, 3, 4, 5, or 6;
   R¹, R², R³, R⁴, R⁵, and R⁶, are each independently H, C₁-C₆ alkyl, C₃-C₆ alkenyl, C₃-C₆ alkynyl, or C₃-C₆ cycloalkenyl;
E and F are independently a bond, O, S, NR⁷, C═O, NR⁷C═O, or CONR⁷;

W is a bond, O, S, NR⁷, substituted or non-substituted ethylene group, ethynylene group, C₃-C₆ cycloalkyl, or a mono- or bicyclic aromatic or heteroaromatic ring of 5-12 atoms, and
X is H, NR⁷R⁸, N⁺ R⁷R⁷R⁸, OH, CO₂H or SH;
   wherein
   R² and R⁸ are independently H, C₁-C₆ alkyl, C₃-C₆ alkenyl, C₃-C₆ alkynyl, or C₃-C₆ cycloalkenyl, or R⁷ and R⁸ together form a 4 to 8-membered ring containing optionally double or triple bonds;
Y is H, OH, NH₂, SH, CH₂OH, CH₂NH₂, CH₂CO₂H or O—CO-A-G-B wherein
A and B are as defined above and G is a bond, substituted or non-substituted ethylene or ethynylene group, and
Z is H⁺, Li⁺, Na⁺, K⁺, NH₄⁺, or mono-, di-, tri- or tetraalkyl ammonium group.

The number of carbon atoms in the group -[B-F-W-E]-A- is preferably 5-21 atoms either in a chain, branched chain or in a cyclic structure or in a combination of these structural units. More preferably the group -[B-F-W-E]-A- is an alkyl or alkenyl group, or aryl alkyl or aryl alkenyl group, or alkyl or alkenyl carboxy group. Most preferably the group -[B-F-W-E]-A- is an alkyl or alkenyl group. The number of carbon atoms between A and X is preferably 7-16 atoms either in a chain, branched chain or in a cyclic structure or in a combination of these structural units.

X is preferably NR⁷R⁸, N⁺ R⁷R⁷R⁸, H, or OH, more preferably NH₂.

Y is preferably OH, NH₂, or H, more preferably OH.

W is preferably phenyl, naphtyl, pyridyl, thienyl, furanyl, pyrrolyl, benzofuranyl, indolyl, quinolinyl, isoquinolinyl, or a non-aromatic heterocyclic ring of 4-6 atoms, such as piperidinyl, morfolinyl, piperazinyl, dihydrofuranyl, pyrrolinydyl, azedidinyl, or oxazetidinyl. Most preferably W is phenyl or naphtyl.

The bisphosphonate reacts in with the metal cation to be collected and forms a complex, which is then separated from the liquid. The collection process is carried out in one liquid phase only, i.e. it is no extraction process. The substituents in formula I are selected so that the bisphosphonate is insoluble or sparingly soluble in the liquid in the reaction conditions and so that the complex formed is insoluble or sparingly soluble.

The collection of metals from liquids is dependent e.g. on the metal, its oxidation state, the bisphosphonate I, pH, temperature, contact time and additional materials used during the collection procedure. Typically, all positively charged metallic elements can be collected except alkali metals. Each metal has also an individual pH range for the collection and an optimum pH value for highest possible collection. The bisphosphonate together with the metals bound to it may be removed from the liquid by filtration.

Based on the different collection properties mentioned above for each metal, the separation of one metal or a group of metals from a mixture of cations is possible. In one embodiment, positively charged ions are separated from negatively charged ions, e.g. Cr³⁺ from Cr⁶⁺, which exist in aqueous solution as dichromate anion (Cr₂O₇²⁻). Also the separation of alkali metals from other metallic cations is straightforward.

No ion exchange resin need to be used with the bisphosphonate. Cellulose or activated charcoal may be used as auxiliary substances to increase the collection efficiency in the separation steps of metal bisphosphonate complexes.

The invention can be used for collecting especially the following metals: Ca, Mg, Pb, Hg, Cd, V, Cr, Ni, As, Zn, Al, Ba, Fe, Sn, Sr, Bi, Mn, Mo, Ga, Nb, Ta, Ag, Cu, Pt, Au, Ru, Rh, Ir, Nd, Sc, La, Y, Eu, Zr and U.

The present invention can be used in many applications related to the purification of aqueous solutions from unwanted metal cations. Typical applications are softening and purification of household water from Ca²⁺, Mg²⁺ and other unwanted metal ions, purification of waste waters of various sources (e.g. drainage water from dumping), separation of one metal or a group of metals from a mixture of cations, preconcentration of diluted liquids for analytical purposes, and collection and concentration of radioactive material to compact size. Invention is especially useful, when heavy metals, like Pb²⁺, Hg⁺, Hg²⁺ or Cd²⁺ are collected from mixtures containing variable amounts of anions and other cations.

The reaction times needed in the method are relatively short.

The concentration of the metal to be collected may be quite low, e.g. as low as ca. 10-500 ppm or even lower. This is a remarkable advantage when harmful metals are removed or precious metals recovered.

The yields of the method are good.

### DETAILED DESCRIPTION OF THE INVENTION

The present invention is directed to bisphoshonates I defined above. The structure is characterized by a P-C-P backbone with a range of substituents at the bridging carbon. The invention is especially directed to the metal collection properties of these compounds. The particular embodiments described herein are intended in all respects to be illustrative but not restrictive. Alternative embodiments will become apparent to those skilled in the art to which the present invention pertains without departing from its scope.

Almost quantitative collection percentages (>95%) can be obtained for Al³⁺, Ga³⁺, Cr³⁺, Fe³⁺, Cu²⁺, Ag⁺, Zn²⁺, Cd²⁺, Sn²⁺, Sn⁴⁺, Pb²⁺, Sb³⁺, Nd³⁺, Sc³⁺, Nb⁵⁺ and Bi³⁺, and collection percentages for the rest of the studied metal cations are between 49-94%.

The present invention is further directed to separate Al³⁺, V⁴⁺, Ag⁺, Ru²⁺, Rh²⁺, Ir²⁺, Pt²⁺, Au³⁺, Hg⁺, Hg²⁺, Pb²⁺, Sb³⁺, Nd³⁺, Sc³⁺, Nb⁵⁺ La³⁺, Eu³⁺, Zr⁴⁺, Y³⁺ or Bi³⁺ from other positively charged metal cations (Ca²⁺, Mg²⁺, Sr²⁺, . . . ). In this process, the metals are collected under different pH values, e.g. collection of Ag⁺ start from pH 1.5 while e.g. Ni²⁺ is collect starting from pH 4.

### General Synthetic Procedures

Compounds of the invention can be prepared from readily available starting materials using the following general methods and procedures. Those skilled in the art will recognize that all aspects of the present invention can be prepared using the methods described herein or by using other methods, reagents and starting materials known to those skilled in the art. It will also be appreciated that where typical or preferred process conditions (i.e. reaction times, mole ratios of reaction, temperatures, solvents, etc.) are given, other process conditions can also be used unless otherwise stated. Optimal reaction conditions may vary with the particular reactants or solvents used.

Conventional protecting groups may be necessary to prevent certain functional groups from undergoing undesired reactions. The choice of suitable protecting groups for a particular functional group, as well as suitable protection and deprotection, are well known in the art. Several examples of numerous possible protection groups, and their introduction and removal, are described in Greene, T. W. and Wuts, G. M., Protection Groups in Organic Synthesis, Fifth Edition, Wiley, New York, 1999, and references cited therein.

The target compound I is possible to prepare based on several approaches depending on the used starting materials or the required substitutions. Recently, a comprehensive review of synthetic methods to prepare various bisphosphonates was published (Abdou, W. M. and Shaddy, A. A. ARKIVOC 2009 (ix) 143). The most common methods to synthesize bisphosphonates are shown in schemes A-D.

The easiest approach to prepare bisphosphonic acids, as shown in scheme A, is started from a trivalent phosphorus species containing a nucleophilic electron pair, which is attached to a carbonyl functionality containing the desired X-[B-F-W-E]ₖ-A-chain and a good leaving group L. In this method several functional groups are allowed in the X-[B-F-W-E]ₖ-A-chain, like alkyl, alkenyl or alkynyl chains, cyclic structures, aromatic rings and functionalities with heteroatoms (e.g. NH₂ or OH). Typically, the leaving group L is —OH, —Cl or —OCOR (anhydride) functionality. The target bisphosphonic acid is obtained after treatment with boiling water.

[chemical structure]

Another approach to bisphosphonic acids is via corresponding esters as shown in scheme B. In this method the other starting material is as above, but now trivalent phosphorus esters are used as phosphorous sources. Generally, the reaction conditions are more gentle here compared to the method above, and this allows more flexibility to choose functional groups in X-[B-F-W-E]ₖ-A-chain. In the last step esters groups are hydrolyzed either to mixed acid esters (partially hydrolyzed) or to tetraacids (Turhanen, P. A. and Vepsäläinen, J. J. Synthesis 2004, 992).

[chemical structure]

The third common method to prepare bisphosphonic acids is started from tetraalkyl methylenebisphosphonates containing at least one hydrogen atom in the bridging carbon as shown in scheme C. In the first step this hydrogen is replaced by a metal atom under basic conditions followed by adding X-[B-F-W-E]ₖ-A-halide to reaction mixture. In the last step the ester groups are hydrolyzed either with water or a silyl reagent to corresponding tetraacidic bisphosphonate. This method allows also to prepare bisphosphonates in which ester groups are hydrolyzed partially to mixed acid esters when Lit, Nat or KI is used as dealkylation agent (Turhanen, P. A. and Vepsäläinen, J. J. Synthesis 2001, 633).

[chemical structure]

In the literature there are several other methods to prepare bisphosphonic compounds, like Arbuzov and Michaelis-Becker reactions. Also the variation of possible starting materials to achieve specific substitution to target bisphosphonate is large. An example of seldom used starting materials is shown in scheme D. In this method X-[B-F-W-E]ₖ-Acyanide is used as starting point to prepare the target bisphosphonates. Especially, this method allows to prepare directly bisphosphonates I in which the Y substituent is NH₂ group (Szajnman, S. H., Ravaschino, E. L., Docampo, R. and Rodriguez, J. B. Bioorg. Med. Chem. Lett. 15 (2005) 4685).

[chemical structure]

Schemes A-D describes some typical methods to prepare P-C-P-backbone containing substituents X-[B-F-W-E]ₖ-A and Y. However, phosphorous ends as acid or ester forms are rather stable for various reagents and reaction conditions which allow functional group modifications largely. Several examples of numerous possible transformations for existing functionalities in X-[B-F-W-E]ₖ-A and Y are described in Larock, R. C., Comprehensive Organic Transformations, second edition, Wiley, John & Sons, 1999, and references cited therein.

### Collection of Metal Ions

In accordance with the present invention, effective techniques for the collection of solubilized metals cations from different aqueous liquids using the compounds defined in formula I have been discovered. The techniques have several applications on various fields in which the collection, concentration or removal of at least a portion of solubilized metal cations from liquids are needed. Typical examples are collection of individual metal or a group metals from liquids, purification of waste water, dumping site drainage water or drilled water from unwanted metals, e.g. heavy metals, softening of water for household consumption, separation of positive and negative metal ions from each other, enrichment or recycling of high price metals, e.g. bismuth, silver and gold, from less valuable metals. These are only some representative examples of possible applications this invention.

In general, in this invention positively charged metal cations are at least partially removed from the liquid using the solid bisphosphonate compounds defined in formula I which are insoluble or sparingly soluble to liquid wherefrom the metals are collected. A compound is considered as insoluble, if its solubility is less than 0.1 g/100 ml, and as sparingly soluble if its solubility is more but still less than 1 g/100 ml. The bisphosphonate compound I acts in liquids as an ion exchange resin and metal cations are bound to phosphorous ends. Compared to present techniques (e.g. Diphonix®) there is no need for additional solid materials since bisphosphonate I acts in the same time as an ion exchange resin and the solid support.

The low solubility is achieved by using long carbon chain(s) or aromatic ring(s) in the bisphosphonate structure I. Advantageously, compound I contains 7-16 carbon atoms either in chain, branched chain or cyclic structure or in combination of these structural units between A and X, and preferably in the chain starting from the P-C-P bridging carbon and the number of heteroatomic functional groups excluding the phosphorous functionalities are limited to two or three groups. The solubility decreases even more if compound I contains functional groups which are capable to form twitter ions with each other. Typical examples of twitter ions are acids (e.g., —CO₂H or —PO₃H₂) and bases (amines) in the same molecule. Solubilities of selected bisphosphonate compounds I were determined with UV/Vis spectrophotometer at 880 nm using molybdenum blue method (Finnish Standard Association SFS 3026: Determination of phosphate in water. Finnish Standard Association SFS, Helsinki Finland, 1986).

Typically, the present metal collection systems are effective in neutral or basic pH values but less effective under acidic medium. As shown in the examples later, bisphosphonate I can effectively collect metal ions also under acidic conditions. Some metals are collected even in very acidic conditions, like vanadium (V⁴⁺) and aluminium (Al³⁺) for which the optimal pH collection ranges are 0-0.5 and 1-2, respectively. In some cases, positively charged metallic elements are collected under vide pH range, like Fe³⁺ (pH 1-11) and Hg²⁺ (pH 2-11). Some elements, like lithium (Li⁺), sodium (Na⁺), potassium (K⁺) and cesium (Cs⁺), and negatively charged elements in aqueous solutions, like Cr(VI), As(III), As(V), Se(IV) and Se(VI) are not removed from the liquids by using bisphosphonate compound I.

The above mentioned pH selectivity is an advantage when metal ions are separated from each other. The simplest example is to separate chromium(III) from chromium(VI), since positively charged Cr³⁺ is collected to bisphoshonate I while Cr⁶⁺, which exists in aqueous solution as dichromate anion (Cr₂O₇²⁻) is not bound. A more complex example is to separate e.g. silver (Ag⁺) from copper (Cu²⁺) and nickel (Ni²⁺) cations based on dissimilar binding properties to compounds I under different pH values. In this case the optimal collection pH range for Ag⁺ start from 1.5 while Cu²⁺ and Ni²⁺ are collect starting from pH 3 and 4, respectively. Generally, positively charged metallic elements, which are collected under acidic conditions, are separated from the cations, which are collected under higher pH value or vice versa. Similar separation is expected for Al³⁺, V⁴⁺, Ru²⁺, Rh²⁺, Ir²⁺, Au³⁺, Hg⁺, Hg²⁺, Pb²⁺, Sb³⁺, Nd³⁺, Sc³⁺, Nb⁵⁺, La³⁺, Eu³⁺, Zr⁴⁺, Y³⁺ or Bi³⁺ from other positively charged metal cations (e.g. Ca²⁺, Mg²⁺, Sr²⁺), for which the optimal collection range starts from a higher pH value.

The collection efficiency is not only dependent on pH but also on the metal concentration in the solution and the amount of bisphosphonate I used. Generally, the results are better when the metal cation concentrations are at ppm or ppb level and the amount of the bisphosphonate is ca. 10-300 times that of the metal cation, which is collected. Under these conditions quantitative (>95%) collection percentages are obtained for several metallic elements, like Al³⁺, Ga⁴⁺, Cr³⁺, Fe³⁺, Cu²⁺, Ag⁺, Zn²⁺, Cd²⁺, Sn²⁺, Sn⁴⁺, Pd²⁺, Sb³⁺, Nb³⁺, Sc³⁺, Nb⁵⁺ and Bi³⁺. The collection percentages for the rest of the studied metal cations are between 49-94%. These results also give an idea of affinity order (equilibrium constant K) of the studied metals to solid bisphosphonate complexation agent I. Numeric K values (binding constants) are extremely difficult to measure using traditional titration methods in this case, since both the bisphosphonate complexation agent and the formed complex are solids.

Moreover, the collection efficiency is increased when cellulose or activated charcoal is used as auxiliary substances in the separation steps of metal bisphosphonate complexes from solutions. Especially, when the amounts of solid metal bisphosphonate complexes are small compared to the volume, the auxiliary substances improve filtration and make it more effective. On the other hand, activated charcoal effectively binds also soluble metal bisphosphonate complexes or fractions from the solutions and makes the separation and collection of these complexes and fractions from solution possible. The collection percentages for copper (Cu²⁺), nickel (Ni²⁺) and iron (Fe²⁺) are increased dramatically when activated carbon is used as an auxiliary substance.

The collection of metal ions from solutions is also dependent on the contact time of complexation agent with the liquid and on the collection temperature. In the case of a single metal cation in a solution, e.g. Mg²⁺, the complexes are formed in minutes, while in more complex solutions, metal selective binding is observed. If the contact time is 30 minutes or shorter, Pb²⁺ and Hg²⁺ ions are bound to the complexation agent ca. 10 times better compared to other studied cations in the same solution. Also with longer contact times these ions have the highest affinity to the complexation agent. Hg²⁺ ions are bound in minutes, Pb²⁺ ions in hours (binding almost quantitative after 6.5 h), while Cd²⁺ and other ions require longer contact times. Even more metal selective bindings is observed when the temperature was varied from 4° C. to 50° C. At lower temperatures (<30° C.) only lead was bound quantitatively, and the selectivity at 4° C. compared to Cd²⁺, Zn²⁺, Al³⁺ and Mn²⁺ was 6, 11, 16 and 21 times better, respectively. Also binding of Cd²⁺ shows some selective at lower temperatures compared to other studied metals, but at 50° C. all studied cations, except Ca²⁺, are bound quantitatively.

Applications Relating to the Collection of Metals from Liquids

In this part of the text there is collected some applications in which the use of the complexation agent I is possible. Most of the applications are related to the purification of waste water from various sources, like dumping place or from toxic waste disposal plant. Advantageously, the invented complexation agent I can efficiently bind heavy metals, like Pb²⁺, Hg²⁺ and Cd²⁺, from liquids containing variable amounts of different elements. Also the softening of water for household consumption is possible since bisphosphonates with low solubility to water are expected to be non-toxic. The invention is also possible to be used for analytical purposes, not only to quantitatively separate cations and anions from each other as shown above, but also to preconcentrate diluted solutions. The invention is also advantageous in mining industry, when high price or uncommon metals are separated from less valuable metals. Other possible applications are the collection of radioactive material and toxic metals, e.g. uranium, from biological systems. These are only representative examples and the use of the complexation agents I is not limited to the examples mentioned here.

The quality of household consumption water in population centres is normally high due to waterworks. However, in the countryside, private wells are rather common and the quality of water depends on the living area and the well type. Typical unwanted metals in private wells are calcium and magnesium affecting hardness of water among some other metal cations like iron (limit 400 μg/l) and manganese (100 μg/l) (http://www.pori.fi/porilab/rajaarvot.htm). Especially in drilled wells the quality of water may be poor due to many other metal cations, like aluminium (200 μg/l), strontium, copper (2 mg/l) and zinc. The invention was tested with two driller water samples obtained from Tampere (DW 1) and Turku (DW 2). Both samples contained high concentration of calcium and magnesium, noticeable amounts of strontium and zinc. DW1 contained also manganese and DW 2 aluminium and copper cations. After the samples had been treated with the complexation agent, all the metal concentrations were reduced remarkably except sodium which remained in the solutions. The quality of water was thus improved significantly.

The invention is also advantageous when applied to the purification of waste waters from various sources. Nowadays not only household and industrial wastes are collected to dumping sites, but also e.g. polluted soils have their own storage. Problems with these places arise because of rain, which affect drainage trough the dumping side. Depending on the dumping side drainage water coming through this area may be contaminated by variable amounts of different elements. Elements which are rich in environment, like calcium, magnesium, aluminum and iron, are not that harmful compared to heavy metals, e.g. lead, cadmium and mercury.

The invention was tested with two drainage water samples TS 1 and TS 2 obtained from polluted soil field and hazardous waste dumping place, respectively. TS 1 contained variable concentrations of Al³⁺, Ba²⁺, Ca²⁺, Mg²⁺, Mn²⁺, Mo⁶⁺, Ni²⁺, and Zn²⁺ cations and TS 2 mostly Ca²⁺ and heavy metal As^{3/5+}, Cd²⁺, Cr³⁺, Pb²⁺, Sr²⁺, Zn²⁺ and Hg²⁺ cations. TS 1 was treated with a bisphosphonate complexation agent 1 and 32-89% removal of the above mentioned cations was observed. Since the concentrations of heavy metals in TS 1 were very low, the sample was spiked with known amounts arsenic, cadmium and lead. The result after the treatment with the complexation agent was as expected, since almost quantitative removal of cadmium and lead was observed, arsenic remained in the solution and the removal efficiency for the rest of the metals was nearly unchanged. In the case of TS 2, mercuri and/or mercuro cations were removed quantitatively, strontium, zinc, lead, cadmium and also arsenic very effectively, while only 23% removal of chromium and iron were observed. In the case of arsenic, cadmium and lead, the observed expulsion percentages are minimum values, since the amounts of these ions after the treatment were below the detection limits. The removal of arsenic from TS 2 is explained as co-precipitation with some other cations in TS 2 sample.

A third dumping site test sample (TS 3) was prepared from ash obtained from a toxic waste disposal plant. This sample contained large quantities of Ca²⁺, K⁺ and Na⁺, which cause problems in removing the rest of the cations. However, rather effective 66% removal of lead was possible from this solution, while the concentrations of the most abundant cations were ca. 100-400 times that of Pb²⁺. Dilution with water to 1:10 (TS 3a) and 1:100 (TS 3b) improved remarkably the collection of aluminum, calcium, strontium and zinc ions. Also cadmium, lead and zinc spiked samples were prepared from TS 3a and TS 3b, since due to the dilution concentrations of these cations were near or below the detection limit after the treatment. The results from these experiments were excellent since quantitative removal of lead and cadmium was observed and 92% of added zinc was removed.

A fourth prepared test sample (TS 4) contained a lot of sodium (6 g/l), ca. 300 mg/l of chromium and variable amounts some other common metal cations, like aluminum, calcium, magnesium and zinc. These kind of rather acidic (pH 3.7) waste waters are typical e.g. for leather industry. Based on the examples above, chromium(III) is collected at a large pH range and the optimal removal is obtained at pH 3.1, but the collection is not that effective compared to other metals due to low binding capacity. This is possible to overcome easily, if the waste solution is treated with a large excess of the complexation agent, the treatment is repeated several times, or the solution is diluted to a large volume. All these methods were tested to TS 4, and the best results were achieved when the waste solution was diluted and the treatment was repeated at least two times. While this kind of acidic solutions are difficult to purify by using other methods, the procedure developed here led to ca. 83-100% removal of chromium.

Based on the experiments above, solid bisphosphonates I are excellent complexation agents to collect various metallic elements from solutions containing variable amounts of different elements. Especially good results are obtained when heavy metals, like cadmium, lead and mercury cations, are collected from matrixes containing other interfering elements. Also other heavy metals like chromium, zinc, strontium and molybdenum are collected well from various matrixes. Moreover, other harmful cations, like aluminium, calcium and magnesium, especially in household consumption waters, are removed efficiently.

The invention is also useful in mining industry, when valuable and/or rare metals are collected from diluted liquids. Nowadays, efficient methods based on precipitation e.g. as sulfides are developed for common metals, like iron, nickel, copper and manganese, but problems arise when rare metals, like iridium, gallium or ruthenium, are separated from ores containing a lot of other more common metals. As shown above, there are several methods to select the metal to be collected, based on the selection of pH, temperature, contact time and capacity. Metals, collected under lower pH value (Al³⁺, V⁴⁺, Ru²⁺, Rh²⁺, Ir²⁺, Pt²⁺, Au³⁺, Hg⁺, Hg²⁺, Pb²⁺, Sb³⁺, Nd³⁺, Sc³⁺, Nb⁵⁺, La³⁺, Eu³⁺, Zr⁴⁺, Y³⁺ or Bi³⁺) are easily separated from those, e.g. Ca²⁺, Mg²⁺ and Sr²⁺, which are bound at a higher pH value. Moreover, at the same time effective concentration to a compact solid form of these elements is possible, e.g. 10000 ml to 1 g or 10 m³ to 1 kg. Selective collection of e.g. Pb²⁺, Hg²⁺, Hg⁺, Cd²⁺ and Zn²⁺ over other metals like Ca²⁺, Mg²⁺ and Ni²⁺ is possible, if the temperature or contact time is varied. Especially useful is the collection of Au³⁺ cations from solutions TS5 which contain variable amounts of several other metals.

The invention is not limited to collecting selected metals from solutions containing mixtures of metal cations at variable amounts, but also several metals may be collected at the same time. In the examples above, the amount of the complexation agent I were limited compared to the total quantity of different metal cations in liquid or the collections were regulated by other selection criteria. Several metals may be collect at the same time, if the quantity of the complexation agent is sufficient compared to the amount of metals which to be collected and the collection is not limited by other selection criteria, e.g. pH. Typically, the simultaneous collection of metals which have sufficient affinity to the complexation agent are possible to collect at the same time. Zn²⁺, Eu³⁺, La³⁺, Nd³⁺, Y³⁺, UO₂²⁺, Nb⁵⁺ and Zr⁴⁺ cations were collected with quantitative yields from TS 5, since these metals are expected to have also highest affinity to complexation agent and the rest of abundant metals in the sample Mg²⁺ and Ni²⁺ with lower affinities are also collected with good yields. All metals with high or moderate affinity to the complexation agent may be collected and concentrated at the same time.

The invention is also advantageous, when specific groups of metals are collected. The selection of metals is based e.g. on pH, temperature, contact time or capacity. Preferably, the metals are selected based on pH. Extremely good results were obtained, when TS 5 was spiked with aluminum, gallium and vanadium cations. Collection was obtained at a very low pH value, in which only spiked metals and Fe³⁺ are expected to have affinity to the complexation agent. TS 5 was treated with the complexation agent at pH 0.5. The result was as expected, since spiked Al³⁺ and V⁴⁺ were collected with quantitative yields, Ga³⁺ with 93% yield and only Fe³⁺ was collected from other metals abundant in TS 5. It is expected that at low pH value Al³⁺, V⁴⁺, Ru²⁺, Rh²⁺, Ir²⁺, Pt²⁺, Au³⁺, Hg⁺, Hg²⁺, Pb²⁺, Sb³⁺, Nd³⁺, Sc³⁺, Nb⁵⁺, La³⁺, Eu³⁺, Zr⁴⁺, Y³⁺ and/or Bi³⁺ cations are separated from the rest of studied cations or vice versa. Also other methods to select the group of metals are possible to use, e.g. Pb²⁺, Hg²⁺ and Hg⁺ are separated from other metals when contact time of complexation agent with the solution is short (e.g. 30 min).

The invention is also possible to be used widely for analytical purposes in which the solid bisphosphonate complexation agents are used to preconcentrate desired metal cations from diluted solutions and/or from matrixes containing various interfering elements. Applications are not limited to separating ions with opposite charge from each other or to collecting selected cations from a mixture of elements based on controlled pH selection. Advantageously, the complexation agents are extremely functional at mg/l (ppm) and μg/l (ppb) concentration levels and quantitative collection under optimal conditions are obtained for Al³⁺, Ga³⁺, Cr³⁺, Fe³⁺, Cu²⁺, Ag⁺, Zn²⁺, Cd²⁺, Sn²⁺, Sn⁴⁺, Pb²⁺, Sb³⁺, Nd³⁺, Sc³⁺, Nb⁵⁺ and Bi³⁺ cations. Also other studied metallic cations are collected with 49-94% yields. Typically, concentration from 1000-10000 to 1 (e.g. 10 000 ml to 1 g of complexation agent) was achieved easily with the complexation agent. Advantageously, the amounts of metals are either measured directly from the solid material e.g. by EDXRF (Energy Dispersive X-ray Fluorescence Spectrometry) or after the solids are decomposed by using microware digestion.

The invention is also advantageous when radioactive material is collected and concentrated to a smaller volume. However, radioactive materials are not allowed to be handled in normal laboratories but according to general rules, chemical behaviours, e.g. reactions and complex formation, are the same for all different isotopes of an element. Advantageously, the invention was used to collect uranium (UO₂²⁺) and it is expected that also other positively charged actinides, e.g. Pu³⁺, PuO₂²⁺, Am³⁺ and AmO₂²⁺, can be collected in a similar manner. Also, the collection and concentration of nuclear waste is obvious, since typical long-lived, like ¹²⁶Sn or ¹⁰⁷Pd, and medium-lived fission isotopes, like ^{113m}Cd, ⁹⁰Sr, are removed from solutions as corresponding non-radioactive isotopes.

The invention also fulfills the criteria of green chemistry, since no additional solid material is needed during the complexation event and the regeneration of the bisphosphonate complexation agent is obtained easily with concentrated acid. The recycling and regeneration of the material was tested with Cu²⁺ solution, which was passed through complexation agent on a sintered disc. The capacity to collect Cu²⁺ cations dropped from 2300 ppm to 860 ppm (ca. 37% from original) between first and 10^{th} recycling cycle, but the value was reduced only 17% between 10^{th} and 20^{th} recycling step.

Many modifications and other embodiments of the inventions set forth herein will come to mind to one skilled in the art to which these inventions pertains having the benefit of the teachings presented in the foregoing descriptions and the associated examples. Therefore, it is to be understood that the invention is not limited to the specific examples of the embodiments disclosed and that modifications and other embodiments are intended to be included within the scope of the appended claims. Although specific terms are employed herein, they are used in a generic and descriptive sense only and not for purposes of limitation.

### Experimental Section

The following synthetic and analytical examples are offered to illustrate the invention, and are not to be construed in any way as limiting the scope of the invention. In the examples below, the following abbreviations have been used. Abbreviations not defined below have their generally accepted meaning.

AAS=atomic absorption spectroscopy, CVAAS=cold vapor atomic absorption spectroscopy, ICP-AES=inductively coupled plasma emission spectroscopy.

### General Procedure for Expulsion Percent Determination in Examples 7-20:

A water solution (110 ml) containing known amount of single cationic element or elements, typically 0.5-200 ppm, was prepared from Merch Titrisol® standard solution. After adjusting pH by using acid (e.g. HCl or HNO₃) or base (e.g. NaOH) to desired initial value, sample A (10 ml) was taken followed by adding 100 mg of selected solid complexation agent. The mixture was stirred at room temperature for 24 h and sample B (10 ml) was taken. Samples A and B were filtrated separately trough 0.2 μm syringe filter and the concentration of the studied element or elements in both solution was determined by using atomic absorption spectrophotometer. The expulsion percent was determined from the concentration differences between the sample solutions A and B.

### Test Solution Used in Examples 12-23

### Test Sample 1 (TS 1):

Drainage water sample was taken from dumping site containing polluted soil: ca. 200 mg/l of Ca²⁺ and Mg²⁺; 0.05-0.3 mg/l of Al³⁺, Ba²⁺, Mn²⁺, Mo⁶⁺, Ni²⁺ and Zn²⁺; ≦0.05 mg/l of As³⁺ (or As⁵⁺), Cd²⁺ and Pb²⁺; pH 3.53.

### Test Sample 2 (TS 2):

Waste water sample from dumping site containing some heavy metals: ca. 2 g/l of Ca²⁺; 0.1-13 mg/ of As³⁺ (or As⁵⁺), Cr³⁺, Fe^{2/3+}, Pb²⁺, Sr²⁺, Zn²⁺ and Hg²⁺; pH 3.56.

### Test Sample 3 (TS 3):

An ash sample (200 g) obtained from toxic waste disposal plant was suspended to water (2.0 l) and stirred for 24 h and filtrated. Approximate metal concentrations (pH 3.62): 1-4 g/l of Ca²⁺, K⁺ and Na⁺, 0.1-0.2 g/l of Al³⁺, Mg²⁺ and Zn²⁺; ≦0.02 g/l of Cd²⁺, Mn²⁺, Pb²⁺ and Sr²⁺.

### Test Sample 4 (TS 4):

A test solution containing 24000 mg/l of Na⁺; 50-2000 mg/l of Ca²⁺, Cr³⁺, K⁺ and Mg²⁺; and trace amount of Al³⁺, Fe^{2/3+}, Mn²⁺, Ni²⁺, Sr²⁺, V⁴⁺, and Zn²⁺ cations were prepared.

### Test Sample 5 (TS 5):

A test solution containing 1-15 mg/l of Al³⁺, Fe^{2/3+}, Mg²⁺, Mn²⁺, Ni²⁺ and Zn²⁺; 0.1-0.9 mg/l of Ca²⁺ and Na⁺; and trace amount of other Cr³⁺, Co²⁺, Cu²⁺, Eu³⁺, La³⁺, Nd³⁺, Y³⁺, UO₂²⁺ and Nb⁵⁺ cations were prepared.

Names of the prepared compounds in examples 1-5 are taken from ChemBioDrawUltra 11.0.

### Examples 1

### 11-Amino-1-hydroxyundecane-1,1-diyldiphosphonic acid (1a)

[chemical structure]

A mixture of 11-aminoundecyl acid (157 g), phosphorous acid (64 g), and methanesulfonic acid (375 ml) was heated to 65° C. followed by adding PCl₃ (140 ml) over 20 min. The mixture was maintained at 65° C. for 48 h and cold water (1 L) was added to ice cold solution with vigorous stirring. After refluxing overnight, the reaction mixture was cooled to 0° C. and the solid product was collected by filtration yielding 1a (270 g) as white solid: ¹H NMR (D₂O, 500 MHz) δ 2.52 (t, 2H, ³J_{HH}=7.0), 1.81 (m, 2H), 1.49 (m, 2H), 1.36 (m, 2H), 1.29-1.18 (m, 14H). ³¹P NMR (D₂O, 202 MHz) 20.4.

For instance the following bisphosphonates can be prepared analogously:

### 8-Amino-1-hydroxyoctane-1,1-diyldiphosphonic acid (1b)

¹H NMR (D₂O): δ 2.62 (2H, t, J=7.0 Hz), 1.93-1.81 (2H, m), 1.61-1.52 (2H, m), 1.50-1.41 (2H, m), 1.39-1.24 (6H, m); ³¹P NMR (D₂O): δ 19.05 (s).

### 9-Amino-1-hydroxynonane-1,1-diyldiphosphonic acid (1c)

¹H NMR (D₂O): δ 2.59 (2H, t, J=7.0 Hz), 1.93-1.79 (2H, m), 1.59-1.50 (2H, m), 1.50-1.38 (2H, m), 1.37-1.21 (8H, m); ³¹P NMR (D₂O): δ 19.30 (s).

### 10-Amino-1-hydroxydecane-1,1-diyldiphosphonic acid (1d)

¹H NMR (D₂O): δ 2.58 (2H, t, J=7.0 Hz), 1.93-1.80 (2H, m), 1.60-1.50 (2H, m), 1.47-1.38 (2H, m), 1.37-1.23 (10H, m); ³¹P NMR (D₂O): δ 19.25 (s).

### 12-Amino-1-hydroxydodecane-1,1-diyldiphosphonic acid (1e)

¹H NMR (D₂O): δ 2.58 (2H, t, J=7.0), 1.92-1.80 (2H, m), 1.58-1.49 (2H, m), 1.46-1.37 (2H, m), 1.36-1.23 (14H, m); ³¹P NMR (D₂O): δ 19.35 (s).

### 16-Amino-1-hydroxyhexadecane-1,1-diyldiphosphonic acid (1f)

³¹P NMR (solid state): δ 32.6.

[chemical structure]

### 1-Hydroxy-11-(methylamino)undecane-1,1-diyldiphosphonic acid (2a)

¹H NMR (D₂O+1 drop of 6 M NaOD, 500 MHz) δ 2.52 (t, 2H, ³J_{HH}=7.0), 1.89 (m, 2H), 1.57 (m, 2H), 1.48 (m, 2H), 1.37-1.26 (m, 14H). ³¹P NMR (D₂O+1 drop of 6 M NaOD, 202 MHz): δ 20.4.

[chemical structure]

### 1,11-Dihydroxyundecane-1,1-diyldiphosphonic acid (2b)

¹H NMR (CD₃OD, 500 MHz) δ 3.54 (t, 2H, ³J_{HH}=6.5), 2.03 (m, 2H), 1.69 (m, 2H), 1.53 (m, 2H), 1.39-1.28 (m, 12H). ³¹P NMR (CD₃OD, 202 MHz): δ 22.0.

[chemical structure]

### 1-Hydroxyhexane-1,1-diyldiphosphonic acid (3a)

¹H NMR (D₂O): δ 1.99-1.87 (2H, m), 1.62-1.52 (2H, m), 1.39-1.25 (4H, m), 0.92-0.83 (3H, m); ³¹P NMR (D₂O): δ 18.68 (s).

### 1-Hydroxynonane-1,1-diyldiphosphonic acid (3b)

¹H NMR (D₂O): δ 1.92-1.80 (2H, m), 1.60-1.48 (2H, m), 1.37-1.21 (10H, m), 0.92-0.83 (3H, m); ³¹P NMR (D₂O): δ 19.36 (s).

### 1-Hydroxyundecane-1,1-diyldiphosphonic acid (3c)

¹H NMR (D₂O): δ 2.00-1.87 (2H, m), 1.61-1.52 (2H, m), 1.38-1.21 (14H, m), 0.90-0.83 (3H, m); ³¹P NMR (D₂O): δ 18.77 (s).

### 1-Hydroxyheptadecane-1,1-diyldiphosphonic acid (3d)

¹H NMR (CD₃OD, 500 MHz) δ 1.94 (m, 2H), 1.60 (m, 2H), 1.30-1.15 (m, 14H), 0.81 (t, 3H, ³J_{HH}=7.0). ³¹P NMR (CD₃OD, 202 MHz): δ 22.0.

[chemical structure]

### (Z)-1-Hydroxyoctadec-9-ene-1,1-diyldiphosphonic acid (4)

¹H NMR (CD₃OD, 500 MHz) δ 5.37-5.30 (2H, m), 2.05-1.97 (4H, m), 1.71-1.65 (2H, m), 1.40-1.24 (20H, m), 0.90 (3H, t, ³J_{HH}=6.5). ³¹P NMR (CD₃OD, 202 MHz): δ 21.4.

[chemical structure]

### 1-Hydroxy-5-phenylpentane-1,1-diyldiphosphonic acid (5a)

¹H NMR (D₂O): δ 7.39-7.22 (5H, m), 2.70-2.63 (2H, m), 2.04-1.92 (2H, m), 1.69-1.59 (4H, m); ³¹P NMR (D₂O): δ 18.60 (s).

### 4-(4-Aminophenyl)-1-hydroxybutane-1,1-diyldiphosphonic acid (5b)

¹H NMR (D₂O+1 drop of 6 M NaOD, 500 MHz) δ 7.21 (d, 2H, ³J_{HH}=8.0), 6.84 (d, 2H, ³J_{HH}=8.5) 2.56 (t, 2H, ³J_{HH}=7.5), 2.00-1.84 (m, 4H). ³¹P NMR (D₂O+1 drop of 6 M NaOD, 202 MHz): δ 20.2.

### Example 2

### 1-Hydroxy-7-phenylheptane-1,1-diyldiphosphonic acid (5c)

³¹P NMR (D₂O): δ 19.3 (bs)

[chemical structure]

### Octane-1,1-diyldiphosphonic acid (6a)

Tetraisopropyl methylenebisphosphonate (8.0 g, 23.2 mmol) was added dropwise to NaH (0.8 g, 60% in oil) in dry THF (40 ml) and the mixture was stirred at room temperature for 1.5 h followed by adding gradually 1-bromoheptane. The mixture was refluxed for 23 h, water (160 ml) was added to the cooled mixture and the product was extracted with CH₂Cl₂ (3×150 ml). After drying solvents were evaporated and the residue was purified by silica gel column chromatography (R_{f}=0.68 EtOAc/acetone, 1:2) to obtain the tetraisopropyl intermediate, which was treated with HCl (4M). After refluxing for 17 h the mixture was evaporated to dryness yielding 6a (4.4 g, 69%) as white solid. ¹H NMR (D₂O): δ 2.23 (1H, tt, ²J_{HP}=23.2 Hz, ³J_{HH}=6.0 Hz), 1.93-1.79 (2H, m), 1.59-1.50 (2H, m), 1.36-1.22 (8H, m), 0.89-0.81 (3H, m); ³¹P NMR (D₂O): δ 22.73 (s).

For instance the following bisphosphonates can be prepared analogously:

### Undecane-1,1-diyldiphosphonic acid (6b)

¹H NMR (CD₃OD): δ 2.16 (1H, tt, ²J_{HP}=23.5 Hz, ³J_{HH}=6.0 Hz), 1.99-1.84 (2H, m), 1.66-1.55 (2H, m), 1.39-1.22 (14H, m), 0.94-0.85 (3H, m); ³¹P NMR (CD₃OD): δ 21.90 (s).

### Tridecane-1,1-diyldiphosphonic acid (6c)

¹H NMR (CD₃OD): δ 2.14 (1H, tt, ²J_{HP}=23.3 Hz, ³J_{HH}=6.2 Hz), 1.98-1.84 (2H, m), 1.65-1.56 (2H, m), 1.37-1.22 (18H, m), 0.92-0.87 (3H, m); ³¹P NMR (CD₃OD): δ 21.71 (s).

### Heptadecane-1,1-diyldiphosphonic acid (6d)

¹H NMR (CD₃OD): δ 2.15 (1H, tt, ²J_{HP}=23.5 Hz, ³J_{HH}=6.0 Hz), 1.98-1.85 (2H, m), 1.66-1.56 (2H, m), 1.37-1.23 (26H, m), 0.93-0.86 (3H, m); ³¹P NMR (CD₃OD): δ 21.80 (s).

[chemical structure]

### Example 3

### 1-Aminononane-1,1-diyldiphosphonic acid (7a)

A mixture of octyl cyanide (1.4 g, 10 mmol), phosphorous acid (1.6 g), and anhydrous benzenesulfonic acid (10 g) was heated to 65° C. under argon atmosphere followed by adding PCl₃ (0.9 ml). The mixture was stirred at 90° C. for 17 h, water (40 ml) was added and the reaction mixture was stirred at room temperature for 1 h. The solid product was collected by filtration yielding 7a (0.9 g, 30%) as white solid. ¹H NMR (D₂O): δ 2.11-2.00 (2H, m), 1.61-1.52 (2H, m), 1.38-1.23 (10H, m), 0.90-0.82 (3H, m); ³¹P NMR (D₂O): δ 12.71 (s).

For instance the following bisphosphonates can be prepared analogously:

### 1-Aminodecane-1,1-diyldiphosphonic acid (7b)

¹H NMR (D₂O): δ 2.06-1.96 (2H, m), 1.58-1.48 (2H, m), 1.33-1.18 (12H, m), 0.85-0.78 (3H, m); ³¹P NMR (D₂O): δ 12.57 (s).

[chemical structure]

### Example 4

### Other Methods to Prepare Bisphosphonates

### 11-Hydroxy-11,11-bis(hydroxy(methoxy)phosphoryl)-N,N,N-trimethylundecan-1-aminium iodine monosodium salt (8a)

Trisodium salt of 1a (2.0 g, 4.8 mmol) was dissolved to water (10 ml) and methyl iodide (4 ml) was added and the mixture was stirred for 2 days at 40° C. The mixture was evaporation to dryness and treatment with Met was repeated twice. The residue was dissolved into acetone, solids were removed and filtrate was evaporated to dryness to yield 8a (2.6 g, 95%) as pale brown solid. ¹H NMR (D₂O, 500 MHz) δ 3.71-3.68 (m, 6H), 3.36 (m, 2H), 3.16 (9H, s), 1.95 (m, 2H), 1.84 (m, 2H), 1.61 (m, 2H), 1.45-1.33 (m, 12H). ³¹P NMR (D₂O, 202 MHz): δ 21.2.

[chemical structure]

### 11-Hydroxy-N,N,N-trimethyl-11,11-diphosphonoundecan-1-aminium chloride (8b)

Compound 6a (1.3 g, 2.3 mmol) was refluxing with 6M HCl (10 ml) for 6 h. The mixture was evaporated to dryness and residue was dissolved to dry MeOH (8 ml), solids were removed and filtrate was evaporated to dryness. The solids were washed with acetone (10 ml) and dried in vacuo to yield 8b (0.88 g, 90%) as yellow solid. ¹H NMR (D₂O, 500 MHz) δ 3.36 (m, 2H), 3.15 (s, 9H), 1.95 (m, 2H), 1.84 (m, 2H), 1.61 (m, 2H), 1.45-1.33 (m, 12H). ³¹P NMR (D₂O, 202 MHz): δ 20.1.

[chemical structure]

### 11-Acetamido-1-hydroxyundecane-1,1-diyldiphosphonic acid (8c)

Prepared from trisodium salt of 1a (1.0 g, 4.8 mmol) and acetic anhydride (5 ml) using the known method (Turhanen, P. A.; Vepsäläinen, J. J. Beilstein J. Org. Chem. 2006, 2, No. 2. doi:10.1186/1860-5397-2-2). After treatment with Dowex H⁺ (50 W×8-200) cation exchange resin 6c (0.78 g, 83%) was obtained as white solid. ¹H NMR (CD₃OD, 500 MHz) δ 3.14 (t, 2H, ³J_{HH}=7.0), 2.02 (m, 2H), 1.67 (m, 2H), 1.92 (s, 3H), 1.49 (m, 2H), 1.38-1.28 (m, 12H); ³¹P NMR (CD₃OD, 202 MHz): δ 21.9.

[chemical structure]

### 11-((2,2-diphosphonoethyl)thio)undecanoic acid (8d)

Ethene-1,1-diyldiphosphonic acid tetraisopropyl ester (2 g) and 11-mercaptoundecanoic acid (1.23 g) in methanol (50 ml) were heated at 40° C. over night followed by adding 4M HCl (50 ml). The mixture was refluxed over night and evarorated to dryness to give 8d (2.28 g, 99%) as white solid. ¹H NMR (CD₃OD, 500 MHz) δ 3.03 (td, 2H, ³J_{PH}=15.8, ³J_{HH}=6.1), 2.58 (t, 2H, ³J_{HH}=7.3), 2.45 (tt, 1H, ³J_{pH}=23.4, ³J_{HH}=6.1), 2.30 (t, 2H, ³J_{HH}=7.4) 1.60 (m, 4H), 1.42 (m, 2H), 1.36-1.27 (m, 8H); ³¹P NMR (CD₃OD, 202 MHz): δ 19.9.

### 6-((2,2-diphosphonoethyl)amino)hexanoic acid (8e)

Prepared as 8d from 6-aminocaproic acid (810 mg) to give 8e (1.96 g, 99%) as white solid. ³¹P NMR (CD₃OD, 202 MHz): δ 19.5 (bs).

### Example 5

### (Z)-1-(Heptadec-8-enoyloxy)ethane-1,1-diyldiphosphonic acid (9a)

To a solution editronate tetramethyl ester (3.9 g, 15 mmol), prepared from dimethyl phosphate and dimethyl acetylphosphonate using the known method (Turhanen, P. A., Ahlgren, M. J., Järvinen, T. And Vepsäläinen J. J. Phosphorus, Sulfur Silicon 170 (2001) 115), in acetonitrile (65 ml) was added oleoyl chloride (5.5. ml, 20 mmol) and mixture was stirred at 55° C. for 72 h. Solvents were removed and the residue was purified by column chromatography using EtOAc-MeOH (9:1) as an eluent. Fractions containing the required intermediate were evaporated to dryness and dissolved into dry acetonitrile followed by adding trimethylssilyl bromide (4.4. equiv.). After stirred for 3 h at 20° C. volatile liquids were evaporated and the residue was dissolved in methanol. The mixture was stirred for 2 h at 20° C., solvents were evaporated and the residue washed with n-hexane to give 9a (1.7 g) as white powder.

¹H NMR (CD₃OD, 500 MHz) δ 5.37-5.30 (2H, m), 2.35 (2H, t, ³J_{HH}=7.5 Hz), 2.03-1.98 (4H, m), 1.93 (3H, t, ³J_{HP}=15.8 Hz), 1.65-1.58 (2H, m), 1.37-1.20 (20H, m), 0.88 (3H, t, ³J_{HH}=6.9 Hz); ³¹P NMR (CD₃OD, 202 MHz): δ 17.9.

For instance the following bisphosphonates can be prepared analogously:

### 1-(Dodecanoyloxy)ethane-1,1-diyldiphosphonic acid (9b)

¹H NMR (CD₃OD, 500 MHz) δ 2.38 (2H, t, ³J_{HH}=7.5 Hz), 1.88 (3H, t, ³J_{HP}=15.3 Hz), 1.67-1.60 (2H, m), 1.39-1.23 (16H, m), 0.90 (3H, t, ³J_{HH}=6.9 Hz); ³¹P NMR (CD₃OD, 202 MHz): δ 17.8.

### 1-(Stearoyloxy)ethane-1,1-diyldiphosphonic acid (9c)

¹H NMR (CD₃OD, 500 MHz) δ 2.38 (2H, t, ³J_{HH}=7.5 Hz), 1.88 (3H, t, ³J_{HP}=15.3 Hz), 1.67-1.60 (2H, m), 1.39-1.23 (28H, m), 0.90 (3H, t, ³J_{HH}=6.9 Hz); ³¹P NMR (CD₃OD, 202 MHz): δ 17.8.

### Example 6

### Solubility of the Compounds

Solubilities of selected compounds were determined with UV/Vis Spectrophotometer at 880 nm using molybdenum blue method from saturated aqueous samples solutions (Finnish Standard Association SFS 3026: Determination of phosphate in water. Finnish Standard Association SFS, Helsinki Finland, 1986). The obtained results are shown in table 1.

TABLE 1
Determined solubilities for the selected complexation agents.

| Compound | MW¹⁾ | mg/l P²⁾ | mg/l³⁾ |
|---|---|---|---|
| 1a | 365.30 | 10 | 59 |
| 1b | 323.22 | 426 | 2222 |
| 1c | 337.24 | 400 | 2175 |
| 1d | 351.27 | 40 | 227 |
| 1e | 379.32 | 5 | 31 |
| 1f | 435.43 | 6 | 42 |
| 2a | 379.33 | 97 | 594 |
| 2b | 366.28 | 3870 | 22882 |
| 3a | 280.15 | 12 | 54 |
| 3b | 344.21⁴⁾ | 1 | 5 |
| 3c | 372.11⁴⁾ | 0.3 | [symbol] |
| 5a | 364.20 | 1.8 | [symbol] |
| 5b | 343.21 | 79 | [symbol] |
| 5c | 370.27 | 0.2 | [symbol] |
| 6b | 334.28 | 0.7 | [symbol] |
| 6c | 362.34 | 0.2 | [symbol] |
| 6d | 418.44 | 0.03 | [symbol] |
| 7a | 321.24 | 0.08 | [symbol] |
| 7b | 335.27 | 0.05 | [symbol] |

¹⁾Calculated as monohydrate;
²⁾solubility calculated as elemental phosphorus;
³⁾solubility calculated for whole molecule; mono sodium salt. [symbol]
indicates data missing or illegible when filed

### Example 7

### pH and Expulsion Percent

Using the above mentioned general procedure optimal expulsion pH ranges for each metal with complexation agent 1a was determined. For each element the expulsion percent was determined in 5-14 different pH value. The obtained results are shown in table below with minimum expulsion percent inside the optimal pH range.

TABLE 2
Determined pH ranges with minimum expulsion percent for
selected elements, when 1a was used as complexation agent.

| | | Expulsion | | | Expulsion |
|---|---|---|---|---|---|
| Element | pH range | [%] | Element | pH range | [%] |
| Li⁺, | 0-12 | <5 | Rh³⁺ | 2-10 | >19 |
| Na⁺, K⁺ | | | | | |
| Ca²⁺ | 4-12 | >50 | Ir³⁺ | 0.0-0.5 | >65 |
| Mg²⁺ | 4-12 | >74 | Ni²⁺ | 4-11 | >40 |
| Sr²⁺ | 4-12 | >80 | Pd²⁺ | 7-12 | >65 |
| Ba²⁺ | 3-12 | >75 | Pt²⁺ | 0-1 | >60 |
| Al³⁺ | 1-2 | >96 | Cu⁺ | 3-11 | >79 |
| Ga³⁺ | 0.5-1 | 100 | Cu²⁺ | 3-11 | >87 |
| Ga³⁺ | 6-11 | >90 | Ag⁺ | 1.5-12 | >84 |
| Ti⁴⁺ | 10-12 | >35 | Au³⁺ | 0-2 | >39 |
| V⁴⁺ | 0-0.5 | >30 | Zn²⁺ | 4-11 | >75 |
| Cr³⁺ | 2.5-12 | >60 | Cd²⁺ | 3-11 | >36 |
| Cr⁶⁺, | 0-12 | <8 | Hg⁺ | 2-11 | >80 |
| As^{3/5+}, | | | | | |
| Ta⁵⁺ | | | | | |
| Mo⁶⁺ | 4-10 | >55 | Hg²⁺ | 2-11 | >90 |
| Mn²⁺ | 4-10 | >69 | Si⁴⁺, Se^{4/6+} | 0-12 | <2 |
| Fe²⁺ | 3-10 | >79 | Sn²⁺ | 8-10 | 100 |
| Fe³⁺ | 1-11 | >55 | Sn⁴⁺ | 7-11 | >91 |
| Ru³⁺ | 2-11 | >55 | Pb²⁺ | 2-9 | >79 |
| Os⁴⁺ | 5-7 | >40 | Sb³⁺ | 0.5-11 | >75 |
| Co²⁺ | 4-11 | >77 | Bi³⁺ | 0.5-4 | 100 |
| Nd³⁺ | 2-8 | >75 | W⁶⁺ | 0.5-3 | >12 |
| Sc³⁺ | 0-12 | >80 | Eu³⁺ | 2-8 | 70 |
| La³⁺ | 0-3.8 | >40 | Zr⁴⁺ | 0-4.8-10 | 60 |
| Y³⁺ | 1.5-4 >10 | >60 | Nb⁵⁺ | 0-12 | >40 |

### Example 8

### Collection of Single Metal Cations from Water Solution

The maximum expulsion percent and pH value in which the value was achieved was determined for each single cationic element using the general procedure mentioned above. The results for compound 1a are collected in Table 3 below.

TABLE 3
Determination of pH values for maximum expulsion percent for
selected elements, when 1a was used as complexation agent.

| Element | pH | ppm¹⁾ | Expulsion-% | Element | pH | ppm¹⁾ | Expulsion-% |
|---|---|---|---|---|---|---|---|
| Li⁺ | 3.9 | 0.5 | 4.8 | Rh³⁺ | 4.0 | 10 | 77.7 |
| Na⁺ | 3.9 | 0.5 | 0 | Ir³⁺ | 0.6 | 100 | 66.1 |
| K⁺ | 4.2 | 1 | 0 | Ni²⁺ | 3.3 | 1 | 78.6 |
| Ca²⁺ | 2.6 | 2 | 69.9 | Pd²⁺ | 8.0 | 5 | 77.8 |
| Mg²⁺ | 2.9 | 0.5 | 64.3 | Pt²⁺ | 0.5 | 25 | 70.0 |
| Sr²⁺ | 5.0 | 2 | 93.2 | Cu⁺ | 2.4 | 2 | 85.3 |
| Ba²⁺ | 3.0 | 10 | 90.2 | Cu²⁺ | 3.5 | 2 | 95.7 |
| Al³⁺ | 2.1 | 10 | 96.9 | Ag⁺ | 2.0 | 1 | 100 |
| Ga³⁺ | 0.5 | 50 | 1.0 | Au³⁺ | 0.5 | 1 | 63.3 |
| In³⁺ | 2.1 | 20 | 73.4 | Zn²⁺ | 3.7 | 0.5 | 94.7 |
| Ti⁴⁺ | 9.8 | 50 | 48.8 | Cd²⁺ | 3.6 | 0.5 | 97.3 |
| V⁴⁺ | 0.5 | 100 | 69.3 | Hg⁺ | 3.0 | 1 | 89.4 |
| Cr³⁺ | 3.1 | 2 | 97.2 | Hg²⁺ | 5.0 | 0.1 | 93.0 |
| Cr⁶⁺ | 6.6 | 2 | 0 | Si⁴⁺ | 1.0 | 50 | 1.3 |
| Mo⁶⁺ | 8.9 | 10 | 80.8 | Sn²⁺ | 7.0 | 50 | 98.1 |
| Mn²⁺ | 3.4 | 1 | 93.8 | Sn⁴⁺ | 10.3 | 200 | 100 |
| Fe²⁺ | 6.5 | 1 | 93.0 | Pb²⁺ | 3.2 | 5 | 99.6 |
| Fe³⁺ | 3.1 | 1 | 98.9 | Sb³⁺ | 3.0 | 10 | 100 |
| Ru³⁺ | 2.0 | 10 | 48.5 | Bi³⁺ | 3.0 | 10 | 100 |
| Os⁴⁺ | 0.5 | 100 | 85.8 | U⁶⁺ | 3.4 | 2.5 | 87.6 |
| Co²⁺ | 3.4 | 1 | 85.0 | Gd³⁺ | 1.5 | 100 | 0 |
| Nd³⁺ | 4.1 | 100 | 98.1 | W⁶⁺ | 1.6 | 50 | 12.0 |
| Sc³⁺ | 2.0 | 5 | 100 | Eu³⁺ | 4.0 | 5 | 85.3 |
| La³⁺ | 3.0 | 100 | 54.1 | Zr⁴⁺ | 0.5 | 100 | 81.5 |
| Y³⁺ | 2.1 | 25 | 89.1 | Nb⁵⁺ | 8.5 | 100 | 100 |

¹⁾Initial concentration of the element

### Example 9

### Collection of Single Metal Cations from Water Solutions without and with Activated Carbon

Using the general procedure described above expulsion percent of Cu²⁺, Ni²⁺ and Fe³⁺ cations were determined at pH 3, when compounds 2a, 2b, 5b, 6b and 6c were used as complexation agents. Experiments were repeated also by adding activated carbon (100 mg) to solution at the same time with the used complexation agent. The results from both experiments are collected in Table 4.

TABLE 4
Determination of expulsion percent of Cu²⁺,
Ni²⁺ and Fe³⁺ cations for selected complexation
agents without and with addition of activated carbon (AC).

| | Expulsion [%] | | | | Expulsion [%] | | |
|---|---|---|---|---|---|---|---|
| Compound | Cu²⁺ | Ni²⁺ | Fe³⁺ | Compound | Cu²⁺ | Ni²⁺ | Fe³⁺ |
| 2a | 16.4 | 13.3 | 44.7 | 2a + AC | 100.0 | 98.5 | 93.3 |
| 2b | 100.0 | 6.9 | 92.6 | 2b + AC | 100.0 | 26.3 | 95.6 |
| 5b | 21.4 | 7.9 | 56.3 | 5b + AC | 96.0 | 22.6 | 100.0 |
| 6b | 1.3 | 17.2 | 3.9 | 6b + AC | 99.1 | 83.3 | 100.0 |
| 6c | 20.8 | 20.8 | 19.0 | 6c + AC | 100.0 | 98.9 | 100.0 |

### Example 10

### Collection Capacity

Capacity of 1a to collect selected metals were determined following the general procedure described above by using 100 ppm starting metal concentration in each experiment and 1a (100 mg) at selected pH. Amounts of removed metals from the mixture were determined by using AAS. Results are collected in table 5 and are given in mg of metal bound to 1 g of 1a.

TABLE 5
Capacity of 1a to collect selected metals
(mg of metal cation bound to 1 g of 1a).

| | | Capacity | | | Capacity |
|---|---|---|---|---|---|
| Element | pH | [mg/g] | Element | pH | [mg/g] |
| Ca²⁺ | 4.0 | 50.9 | Mo⁶⁺ | 9.1 | 97.2 |
| Cu²⁺ | 4.0 | 61.6 | Ag⁺ | 2.5 | 94.6 |
| Ni²⁺ | 4.0 | 13.1 | Co²⁺ | 4.5 | 85.5 |
| Zn²⁺ | 4.0 | 70.9 | Cr³⁺ | 3.5 | 9.9 |
| Au³⁺ | 4.0 | 19.0 | Fe²⁺ | 3.0 | 82.7 |
| Cd²⁺ | 4.0 | 74.1 | Fe³⁺ | 3.0 | 15.2 |
| Pb²⁺ | 4.0 | 85.6 | Sc³⁺ | 2.0 | 16.9¹⁾ |

¹⁾Sc³⁺ capacities at pH 2 for 1d, 1e, 1f were 29.1, 15.4, 18.1 mg/g, respectively.

### Example 11

### Effect of Complezation Agent Amount Expulsion Percent

Effect of amount of complexation agent 1a to expulsion percent was tested with 2.0 ppm calcium (Ca²⁺) solution. A solution (100 ml) containing 2.0 ppm of calcium was stirred for 24 h with desired amount of complexation agent 1a (25 to 301 mg) at pH 2.9. Expulsions percent were determined for each solution using the general procedure and the results are collected in Table 6.

TABLE 6
Expulsion percent of Ca²⁺ compared to amount of
complexation agent 1a in the case of 2 ppm calcium solution.

| Amount of 1a [mg] | Expulsion [%] |
|---|---|
| 25 | 41.3 |
| 52 | 45.9 |
| 75 | 53.6 |
| 101 | 59.4 |
| 125 | 63.6 |
| 150 | 67.1 |
| 175 | 70.2 |
| 200 | 71.0 |
| 225 | 76.6 |
| 250 | 79.6 |
| 275 | 85.6 |
| 301 | 83.5 |

### Example 12

### Effect of Temperature to Expulsion Percent

Effect of temperature to selected metal expulsion per cents was tested using TS 5 with comlexation agent 1a. TS 5 (100 ml), spiked with known amounts of lead (Pb²⁺) cations, was stirred with 1a (1.0 g) at selected temperature for 24 h followed by separation of 1a by filtration trough 0.2 μm syringe filter. Metal concentrations at 4° C., 7° C., 22° C., 30° C., 40° C. and 50° C. were determined by using ICP-AES analysis. Expulsion per cents were calculated comparing these results to initial metal concentrations in TS 5 and results are given in Table 7.

TABLE 7
Effect of temperature to expulsion percent in the
case of TS 5 by using 1a as complexation agent.

| | Expulsion [%] | | | | | | | | |
|---|---|---|---|---|---|---|---|---|---|
| Temperature | Al³⁺ | Ca²⁺ | Cd²⁺ | Fe^{2/3+} | Mg²⁺ | Mn²⁺ | Ni²⁺ | Pb²⁺ | Zn²⁺ |
| 4° C. | 6.3 | 0.0 | 16.1 | 0.0 | 0.7 | 4.6 | 0.9 | 98.1¹ | 9.0 |
| 7° C. | 15.4 | 0.0 | 18.3 | 0.7 | 0.7 | 5.3 | 1.4 | 98.1¹ | 10.4 |
| 22° C. | 18.5 | 9.4 | 34.5 | 5.2 | 7.1 | 14.7 | 4.6 | 98.1¹ | 22.9 |
| 30° C. | 14.6 | 10.0 | 41.3 | 4.4 | 5.5 | 13.3 | 4.6 | 98.1¹ | 25.7 |
| 40° C. | 98.0 | 63.5 | 99.0 | 99.3 | 97.7¹ | 99.7¹ | 97.1 | 98.1¹ | 97.6 |
| 50° C. | 97.6 | 71.2 | 98.9 | 99.3¹ | 97.7¹ | 99.7¹ | 95.2 | 98.1¹ | 98.0 |

¹Minimum expulsion [%], since amount of element below the detection limit after treatment with 1a.

### Example 13

### Effect of Contact Time to Expulsion Percent

Effect of contact time to selected metal expulsion per cents was tested using TS 5 with comlexation agent 1a. TS 5 (100 ml), spiked with known amounts of lead (Pb²⁺) and mercury (Hg²⁺) cations, was stirred with 1a (100 mg) for selected times followed by separation of 1a by filtration trough 0.2 μm syringe filter. Metal concentrations after 5 min, 15 min, 30 min, 1 h, 2 h, 3.5 h, 6.5 h and 29.5 h were determined by using ICP-AES analysis. Expulsion per cents were calculated comparing these results to initial metal concentrations in TS 5. Results are shown in Table 8.

TABLE 8
Collection of selected metals from Pb²⁺ and Hg²⁺ spiked TS
5, when contact time with complexation agent 1a was varied.

| Time | Expulsion [%] | | | | | | | | | |
|---|---|---|---|---|---|---|---|---|---|---|
| [min] | Al³⁺ | Ca²⁺ | Cd²⁺ | Fe^{2/3+} | Mg²⁺ | Mn²⁺ | Ni²⁺ | Pb²⁺ | Zn²⁺ | Hg²⁺ |
| 5 | 8.3 | 2.7 | 2.9 | 0 | 1.4 | 3.4 | 1.4 | 28.5 | 2.5 | 59.9 |
| 15 | 5.5 | 0 | 3.9 | 0.7 | 1.8 | 4.3 | 1.8 | 34.7 | 3.7 | 60.4 |
| 30 | 7.1 | 0 | 5.1 | 0 | 0.2 | 4.3 | 1.4 | 56.3 | 4.9 | 58.5 |
| 60 | 5.9 | 0 | 7.5 | 3.0 | 4.4 | 6.3 | 4.1 | 49.4 | 6.5 | 56.4 |
| 120 | 8.7 | 0 | 10.9 | 6.7 | 5.8 | 10.5 | 5.0 | 65.7 | 9.8 | 57.1 |
| 210 | 18.5 | 0 | 15.0 | 8.9 | 6.9 | 13.1 | 7.8 | 89.8 | 13.9 | 55.7 |
| 390 | 26.0 | 9.8 | 28.1 | 20.7 | 16.4 | 27.0 | 13.2 | 94.6 | 27.1 | 57.0 |
| 1770 | 27.2 | 18.7 | 36.6 | 19.3 | 19.8 | 29.1 | 15.5 | 98.1 | 30.8 | 49.6 |

### Example 14

### Separation of Cr(III) from Cr(VI)

An aqueous solution (100 ml) containing 1.72 ppm of Cr(III) and 1.89 ppm of Cr(VI) was prepared from Merch Titrisol® standard solution and pH was adjusted to 4.0. Following the general procedure described earlier the mixture was treated with 1a (100 mg) and expulsion per for Cr(III) and Cr(VI) were calculated to be 97.0% and 0%, respectively.

### Example 15

### Drilled Well Water Softening and Purification

Drilled well sample 1 (DW 1) was nearby Tampere and sample 2 (DW 2) nearby Turku. Samples (100 ml each) were stirred with 1a (1.0 g) for 24 h. The initial and final metal concentrations in solutions of selected metals were determined by using ICP-AES analysis after filtration and results are shown in Table 9.

TABLE 9
Softening and purification on selected metals from
drilled well water by using complexation agent 1a.

| | Element | | | | | | | |
|---|---|---|---|---|---|---|---|---|
| | Al³⁺ | Ca²⁺ | Cu²⁺ | Mg²⁺ | Mn²⁺ | Na⁺ | Sr²⁺ | Zn²⁺ |
| Concentration | mg/l | mg/l | mg/l | mg/l | mg/l | mg/l | mg/l | mg/l |
| DW 1¹⁾ | <0.05 | 43.8 | <0.05 | 10.9 | 0.095 | 15.2 | 0.097 | 0.044 |
| After 1a²⁾ | <0.05 | 0.232 | <0.05 | <0.1⁴⁾ | <0.02⁴⁾ | 13.5 | <0.02⁴⁾ | 0.018 |
| Expulsion [%] | nd⁴⁾ | 99 | nd⁴⁾ | 99⁵⁾ | 79⁵⁾ | 11 | 79⁵⁾ | 59⁵⁾ |
| DW 2³⁾ | 0.107 | 22.2 | 0.271 | 13.60 | <0.02 | 19.0 | 0.113 | 0.284 |
| After 1a²⁾ | <0.05⁴⁾ | 0.479 | <0.05⁴⁾ | 0.102 | <0.02 | 17.3 | 0.029 | 0.026 |
| Expulsion [%] | 53⁵⁾ | 98 | 82⁵⁾ | 99 | nd⁴⁾ | 9 | 74 | 91 |

¹⁾DW 1 (pH 7.04) was taken from drilled well nearby Tampere;
²⁾Sample was treated with 1a;
³⁾DW 2 (pH 6.97) was taken from drilled well nearby Turku;
⁴⁾amount of element below the detection limit;
⁵⁾minimum expulsion [%].

### Example 16

### Purification of Water Draining Through the Dump Site

Test Sample 1 (TS 1, 100 ml), which initial metal cation concentrations were determined by using ICP-AES method, was treated with 1a (1.0 g) with stirring for 24 h. After filtration trough 0.2 μm syringe filter metal concentrations in solution were determined and removal per cents were calculated. Since TS 1 contained only small amounts of As, Cd and Pb, sample was spiked with known amounts of these metal cations. The spiked sample (100 ml) was treated with 1a (1 g) as original TS 1 sample. Results from both experiments are given in Table 10.

TABLE 10
Purification of drainage water from polluted soil.
Sample D was as C but spiked with As, Cd and Pb.

| | Expulsion [%] | | | | | | | | | | |
|---|---|---|---|---|---|---|---|---|---|---|---|
| Element | Al³⁺ | As^{3/5+} | Ba²⁺ | Ca²⁺ | Cd²⁺ | Mg²⁺ | Mn²⁺ | Mo²⁺ | Ni²⁺ | Pb²⁺ | Zn²⁺ |
| TS 1 | 76 | nd¹⁾ | 32 | 51 | nd¹⁾ | 81 | 57²⁾ | 58²⁾ | 50 | nd¹⁾ | 89 |
| Spiked TS 1³⁾ | 67 | 0 | 26 | 48 | 96 | 78 | 51²⁾ | 52²⁾ | 33 | 94 | 90 |

¹⁾Amount of element below the detection limit;
²⁾Minimum expulsion [%], since amount of element below the detection limit after treatment with 1a;
³⁾Sample spiked with As²⁺ (initial concentration 1.06 mg/l and final 1.06 mg/l), Cd²⁺ (1.030 and 0.038 mg/l) and Pb²⁺ (2.780 and 0.166 mg/l).

### Example 17

### Purification of Waste Water Containing Heavy Metals

TS 2 (100 ml), which initial metal cation concentrations were determined by AAS and ICP-AES methods, was treated with 1a (1.0 g) with stirring for 24 h. After filtration trough 0.2 μm syringe filter metal concentrations in solution were determined. The calculated expulsion per cents are given in Table 11.

TABLE 11
Purification of TS 2 from heavy metals by using complexation agent 1a.

| | Expulsion [%] | | | | | | | | |
|---|---|---|---|---|---|---|---|---|---|
| Element | As^{3/5+} | Ca²⁺ | Cd²⁺ | Cr³⁺ | Fe^{2/3+} | Pb²⁺ | Sr²⁺ | Zn²⁺ | Hg^{1/2+} |
| TS 2 | 61.7²⁾ | 75.4 | 89.4⁵⁾ | 23.9 | 22.8 | 68.9⁵⁾ | 84.3 | 76.8 | 99.0¹⁾ |

¹⁾amount of Hg was determined by using CVAAS method;
²⁾Minimum expulsion [%], since amount of element below the detection limit after treatment with 1a.

### Example 18

### Purification of Ash Water Obtained from Toxic Waste Disposal Plant

TS 3, TS 3 diluted to 1:10 (TS 3a), TS 3 diluted to 1:100 (TS 3b) and Cd²⁺, Pb²⁺ and Zn²⁺ spiked samples TS 3a and TS 3b were each treated with 1a (1.0 g) with stirring for 24 h. These five samples were separately filtrated trough 0.2 μm syringe filter and metal concentrations in each solution were determined by ICP-AES method before and after treatment with 1a. The calculated expulsion per cents are shown in Table 12.

TABLE 12
Purification of waste water obtained from ash containing
toxic metals by using 1a as complexation agent.

| | Expulsion [%] | | | | | | | | | |
|---|---|---|---|---|---|---|---|---|---|---|
| Element | Al³⁺ | Ca²⁺ | Cd²⁺ | K⁺ | Mg²⁺ | Mn²⁺ | Na⁺ | Pb²⁺ | Sr²⁺ | Zn²⁺ |
| TS 3 | 3.4 | 1.9 | 2.1 | 2.9 | 1.5 | 1.9 | 10.8 | 65.7 | 2.1 | 3.6 |
| TS 3a¹⁾ | 71.8⁵⁾ | 88.1 | nd | 0 | nd | nd | 2.0 | 35.5⁵⁾ | 12.5 | 0.0 |
| TS 3b²⁾ | nd⁶⁾ | 93.1 | nd | 1.6 | nd | nd | 9.9 | nd | 53.4 | 48.5⁵⁾ |
| Spiked TS 3a³⁾ | 79.3⁵⁾ | 88.9 | 75.6 | 1.8 | nd | nd | 3.5 | 97.8⁵⁾ | 14.6 | 93.6 |
| Spiked TS 3b⁴⁾ | nd | 95.2 | 96.2 | 0.8 | nd | nd | 7.1 | 98.1⁵⁾ | 60.2 | 91.3 |

¹⁾TS 3 diluted 1:10;
²⁾TS 3 diluted 1:100;
³⁾TS 3a spiked with Cd²⁺ (initial concentration 1.01 mg/l, final 0.25 mg/ml), Pb²⁺ (4.55 mg/ml and 0.10 mg/ml) and Zn²⁺ (1.34 mg/ml and 0.09 mg/ml);
⁴⁾TS 3b spiked with Cd²⁺ (1.07 mg/l, 0.04 mg/ml), Pb²⁺ (5.26 mg/ml and 0.10 mg/ml) and Zn²⁺ (1.12 mg/ml and 0.10 mg/ml);
⁵⁾minimum expulsion [%], since amount of element below the detection limit after treatment with 1a;
⁶⁾nd = not detected, because amount of element below the detection limit.

### Example 19

### Removal of Cr³⁺ from Acidic Solution

TS 4 was diluted to 1:100 with water, pH (3.67) of the solution was determined and sample A was taken. A part (50 ml) of the diluted solution was treated with 1a, 6d or 7a (1.0 g) for 24 h with stirring at room temperature. After filtration trough 0.2 μm syringe filter, the expulsion per for Cr(III) was determined compared to original solution A. The results of expulsion per cents of Cr³⁺ and some other elements are given in Table 13.

TABLE 13
Removal of Cr³⁺ from TS 4 with 1a.

Expulsion [%]

| Element | Ca²⁺ | Cr³⁺ | K⁺ | Mg²⁺ | Na⁺ | Zn²⁺ |
|---|---|---|---|---|---|---|
| 1a | 67 | 91 | 36 | 74 | 14 | >39¹⁾ |
| 6d | 11 | 100 | 52 | 80 | 39 | ²⁾ |
| 7a | ²⁾ | 85 | ²⁾ | ²⁾ | ²⁾ | ²⁾ |

¹⁾Minimum expulsion [%], since amount element below the detection limit;
²⁾ not determined.

### Example 20

### Separation of Silver with Complexation Agent by Using HCl Elution

A mixture of Cu(NO₃)₂×3H₂O (20 ml, 0.1 M), AgNO₃ (20 ml, 0.1 M), Fe(NO₃)₃ (20 ml, 0.1 M), water (40 ml) and 1a (10 g) were stirred for 48 h at room temperature. Solids were collected to sintered disc (porosity G-4), washed with water (60 ml) and eluted with 0.01 M (60 ml), 0.1 M (60 ml) and 1 M (60 ml) HCl solutions. Amounts of each metals in eluted HCl solutions were determined by AAS using standard procedures. Based on these results the end concentration for each metal in solid complexation agent 1a were calculated and results are shown in Table 14.

TABLE 14
Collection of silver with 1a from a solution containing
a mixture of Ag⁺, Cu²⁺ and Fe³⁺ ions.

| | Ag⁺ | Cu²⁺ | Fe³⁺ |
|---|---|---|---|
| | mg/l | mg/l | mg/l |
| Initial concentration | 2050 | 1310 | 1040 |
| Concentration after 1a | 730 | 1100 | 960 |
| Amounts of metals in 1a | 1320 | 210 | 80 |
| Metals in 0.01M HCl | 10 | 0 | 10 |
| Metals in 0.1M HCl | 0 | 10 | 10 |
| Metals in 1M HCl | 10 | 200 | 60 |
| End concentration in 1a | 1300 | 0 | 0 |

### Example 21

### Collection of Gold from TS 5 with Compound 1a

TS 5 (100 ml) was spiked with Au³⁺ (87.7 mg/ml) Merch Titrisol® standard solution. After pH of the mixture was adjusted to 3.0 by HNO₃ sample A was taken followed by adding 1a (5 g). The mixture was stirred at room temperature for 24 h and a sample B was taken. Samples A and B were filtrated separately trough 0.2 μm syringe filter and the concentration of selected element in both solution was determined by using ICP-AES method. The expulsion percent for selected elements were determined from the concentration differences between the samples A and B. Results of gold recovery from TS 5 is given in Table 15.

TABLE 15
Collection of gold from TS 5 by using 1a as a complexation agent.

| Element | Al³⁺ | Au³⁺ | Fe^{2/3+} | Mg²⁺ | Mn²⁺ | Cr³⁺ | Ni²⁺ | Zn²⁺ |
|---|---|---|---|---|---|---|---|---|
| Expulsion [%] | 87.9 | 65.0¹⁾ | 96.6²⁾ | 0 | 0 | 2.6 | 1.3 | 1.4 |

¹⁾Final concentration of gold was 30.7 mg/ml;
²⁾Minimum expulsion [%], since amount of element was below the detection limit after treatment with 1a.

### Example 22

### Simultaneous collection of Ni²⁺, Zn²⁺, Eu³⁺, La³⁺, Nd³⁺, Y³⁺, UO₂²⁺, Nb⁵⁺ and Zr⁴⁺

TS 5 (100 ml) was stirred with 1a (1 g) at room temperature for 24 h. After filtration trough 0.2 μm syringe filter metal concentration of Ni²⁺, Zn²⁺, Eu³⁺, La³⁺, Nd³⁺, Y³⁺, UO₂²⁺, Nb⁵⁺ and Zr⁴⁺ were determined by using ICP-AES and ICP-MS methods. The expulsions percent was calculated for each element from the concentration difference between initial and final solutions and the experimental results are given in Table 16.

TABLE 16
Simultaneous collection of Ni²⁺, Zn²⁺, Eu³⁺, La³⁺, Nd³⁺, Y³⁺, UO₂²⁺,
Nb⁵⁺ and Zr⁴⁺ from TS 5 by using 1a as a complexation agent.

| Element | Ni²⁺ | Zn²⁺ | Eu³⁺ | La³⁺ | Nd³⁺ | Y³⁺ | UO₂²⁺ | Nb⁵⁺ | Zr⁴⁺ |
|---|---|---|---|---|---|---|---|---|---|
| Expulsion [%] | 72 | 97 | 98 | 100 | 100 | 100 | 100 | 100 | 100 |

### Example 23

### Simultaneous collection of Al, Ga and V from TS 5 with compound 1a

TS 5 (100 ml) was spiked with known amounts of Al³⁺, Ga³⁺ and V⁴⁺ Merch Titrisol® standard solutions. After pH of the mixture was adjusted to 0.5 by HNO₃ sample A was taken followed by adding 1a (10 g). The mixture was stirred at room temperature for 24 h and sample B was taken. Samples A and B were filtrated separately trough 0.2 μm syringe filter and the concentrations of the studied elements in both solution were determined by using ICP-AES method. The expulsion percent for each element were determined from the concentration differences between the sample A and B. The experimental results are given in Table 17.

TABLE 17
Simultaneous collection of Al³⁺, Ga³⁺ and V⁴⁺ from
TS 5 by using 1a as an complexation agents..

| Element | Al³⁺ | Ga³⁺ | V⁴⁺ | Fe^{2/3+} | Mg²⁺ | Mn²⁺ | Cr³⁺ | Ni²⁺ | Zn²⁺ |
|---|---|---|---|---|---|---|---|---|---|
| Expulsion [%] | 99.8¹⁾ | 93.2²⁾ | 99.7³⁾ | 97.0⁴⁾ | 0 | 9 | 0 | 0 | 23 |

¹⁾Al³⁺: initial 105.0 mg/ml, final 0.2 mg/ml;
²⁾Ga²⁺: initial 109.2 mg/ml, final 7.4 mg/ml;
³⁾V⁴⁺: initial 104.0 mg/ml, final 0.3 mg/ml;
⁴⁾Minimum expulsion [%], since amount of element was below the detection limit after treatment with 1a.

### Example 24

### Concentration of Diluted Samples

A water solution (100 ml) containing 100 ppb of desired metallic element prepared from Merch Titrisol® standard was diluted to 10 liters of water, pH was adjusted and the mixture was treated with 1e (1 g) for 24 h with stirring. After filtration trough sintered disc (porosity G-4), the solids were decomposed by using microware digestion, the residue was dilution to known volume of water (10 ml) and metal concentrations were determined by using AAS method. The recoveries are given in Table 18.

TABLE 18
Recovery of selected metals with 1e after 1:10000 dilution.

| Element | pH | Yield [%] | Element | pH | Yield [%] |
|---|---|---|---|---|---|
| Hg⁺ | 2.0 | 89 | Cd²⁺ | 3.6 | 98 |
| Hg⁺ | 5.0 | 92 | Pb²⁺ | 3.2 | 100 |
| Hg⁺ | 9.2 | 92 | Pb²⁺ | 5.0 | 85 |
| Hg²⁺ | 2.0 | 93 | Cr³⁺ | 3.0 | 98 |
| Hg²⁺ | 4.9 | 94 | Cr³⁺ | 7.0 | 97 |
| Hg²⁺ | 9.2 | 94 | UO₂²⁺ | 3.0 | 87 |

### Example 25

### Collection of Sc³⁺ from Silicate Soil

Silicate soil (1000 g) was spiked with S₂O₃ (767 mg). A sample (200 mg) was weighted to Teflon vial followed by adding concentrated HCl (9 ml) and HNO₃ (3 ml) solutions. The mixture was heated under microwave for 50 min followed by adding HF (3 ml) and microvawe heating was continued until solids were dissolved totally. The resulting solution was treated with 4% H₃BO₃ (10 ml) with heating and sample A (5 ml) was taken. The rest of the solution (20 ml) was treated with 1a (100 mg) at room temperature for 24 h. After filtration trough 0.2 μm syringe filter Sc³⁺ concentration before and after treated was determined by using AAS method to give 87% recovery of Sc³⁺.

### Example 26

### Collection of Cu²⁺ Ions from Solution with the Prepared Bisphosphonates

A solution containing 1.00 ppm of Cu²⁺ cations at pH 3 was prepared and 50 ml of that solution was treated with the desired solid bisphosphonate (50 mg) using the procedure described in general procedure. Collection-% was determined for the following compounds (Cu²⁺ collection-% in parenthesis): 3a (16%), 3b (88%), 3c (93%), 4 (95%), 5a (20%), 5b (18%), 5c (85%), 6b (48%), 6c (100%), 6d (100%), 7a (88%), 7b (100%), 8b (85%), 8c (88%), 8d (94%), 8e (73%) and 9b (76%).

### Example 27

### Recycling and Regeneration of Solid Bisphosphonate Material

Compound 1a (700 mg) was weighed on sintered disc (porosity G-4) and aqueous CuCl₂x2 H₂O (20 ml) solution containing ca. 47 700 ppm of copper was passed slowly through the powder under vacuum. During this filtration process color of 1a changed from white to blue indicating that copper was bound to solid bisphosphonate powder. After the sintered disc was dry, aqueous HCl (25 ml, 2M) was passed slowly through the sintered disc. During this regeneration process solid bisphoshonate material on sintered disc turned from blue to white and filtered HCl solution was pale blue. The same procedure using the original 1a powder on sintered disc and a fresh CuCl₂x2 H₂O (20 ml) solution was repeated 20 times. The copper concentrations measured by AAS of the filtered HCl solution was 2294 ppm, 859 ppm and 713 ppm after first, 10^{th} and 20^{th} regeneration cycle, respectively. The amount of 1a after the last regeneration step was 630 mg (90% of the original amount).

1. A method for collecting metals from a solution, in which method a bisphoshonate of formula I [chemical structure]
wherein:
A is a (CR¹R²)ₘ—(CR³R⁴)ₙ—(CR⁵R⁶)ₒ— chain,
B is a (CR¹R²)ₘ—(CR³R⁴)ₙ—(CR⁵R⁶)ₒ— chain,
wherein
k is 0, 1, or 2,
m is 0, 1, 2, 3, 4, 5 or 6,
n is 0, 1, 2, 3, 4, 5 or 6,
o is 0, 1, 2, 3, 4, 5, or 6;
R¹, R², R³, R⁴, R⁵ and R⁶, are each independently H, C₁-C₆ alkyl, C₃-C₆ alkenyl, C₃-C₆ alkynyl, or C₃-C₆ cycloalkenyl;
E and F are independently a bond, 0, 5, NR⁷, C═O, NR⁷C═O, or CONR⁷;
W is a bond, 0, 5, NR⁷, substituted or non-substituted ethylene group, ethynylene group, C₃-C₆ cycloalkyl, or a mono- or bicyclic aromatic or heteroaromatic ring of 5-12 atoms, and
X is H, NR⁷R⁸, N⁺ R⁷R⁷R⁸, OH, CO₂H, or SH;
wherein
R⁷ and R⁸ are independently H, C₁-C₆ alkyl, C₃-C₆ alkenyl, C₃-C₆ alkynyl, or C₃-C₆ cycloalkenyl, or R⁷ and R⁸ together form a 4-8 membered ring containing optionally double or triple bonds;
Y is H, OH, NH₂, SH, CH₂OH, CH₂NH₂, CH₂CO₂H or O—CO-A-G-B, wherein
A and B are as defined above and G is a bond, substituted or non-substituted ethylene or ethynylene group; and
Z is H⁺, Li⁺, Na⁺, K⁺, NH₄⁺, or mono-, di-, tri- or tetraalkyl ammonium group;
the substituents being selected so that the compound I is solid and insoluble or sparingly soluble;
is mixed with the solution, whereby metals possibly present in the solution react with the bisphosphonate whereby a solid insoluble complex is formed, and
the complex is separated from the solution.

2. The method according to claim 1, wherein the number of carbon atoms in the group -[B-F-W-E]-A- is 5-21 atoms either in a chain, branched chain or in a cyclic structure or in a combination of these structural units.

3. The method according claim 2, wherein
the group -[B-F-W-E]-A- is an alkyl or alkenyl group, or aryl alkyl or aryl alkenyl group, or alkyl or alkenyl carboxy group.

4. The method according claim 3, wherein the group -[B-F-W-E]-A- is an alkyl or alkenyl group.

5. The method according to claim 1, wherein X is NR⁷R⁸, N⁺R⁷R⁷R⁸, H, OH, or COOH.

6. The method according to claim 5, wherein X is NH₂.

7. The method according to claim 1, wherein Y is OH, NH₂, or H.

8. The method according to claim 7 wherein X is OH.

9. The method according to claim 1, wherein the bisphosphonate together with the metals reacted with it is separated from the solution by filtration.

10. The method according to claim 1, wherein the metal is Ca, Mg, Pb, Hg, Cd, V, Cr, Ni, As, Zn, Al, Ba, Fe, Sn, Sr, Bi, Mn, Mo, Ga, Nb, Ta, Ag, Cu, Pt, Au, Ru, Rh, Ir, Nd, Sc, La, Y, Eu, Zr or U.

11. The method according to claim 1, wherein cellulose or activated charcoal is added into the liquid.

12. The method according to claim 1, wherein the liquid is waste water, or water for household consumption.

13. (canceled)
